(19) United States
(12) Patent Application Publication
(10) Pub. No.: US 2016/0189830 A1
(43) Pub. Date: Jun. 30, 2016

(54) WIRE HARNESS AND WIRE HARNESS MANUFACTURING METHOD

(71) Applicant: Sumitomo Wiring Systems, Ltd, Suzuka-city (JP)

(72) Inventors: Masataka Wakabayashi, Yokkaichi (JP); Minoru Fukuda, Yokkaichi (JP)

(73) Assignee: Sumitomo Wiring Systems, Ltd, Yokkaichi (JP)

(21) Appl. No.: 14/964,908

(22) Filed: Dec. 10, 2015

(30) Foreign Application Priority Data
Dec. 24, 2014 (JP) 2014-260641

(51) Int. Cl. H01B 13/012; H01B 7/282; H01B 13/00; H01B 7/00

(52) U.S. Cl. CPC H01B 13/01263; H01B 7/0045; H01B 7/282; H01B 13/0016

(57) ABSTRACT

A wire harness that can reliably waterproof spaces between an intermediate splice portion and element wires of lead wire exposed portions is provided. The wire harness includes an electrical line group, a water stopper, and a sealing agent. The electrical line group has an intermediate splice portion that electrically connect exposed portions of the lead wire of multiple sheathed electrical lines. The water stopper integrally covers the intermediate splice portion and the exposed portions of the lead wires. The sealing agent is applied to the surface of the water stopper that faces the electrical line group. The water stopper is a heat-shrinking material that shrinks in a direction orthogonal to the axial direction of the lead wire, and is formed into a tube by wrapping the sheet around the electrical line group and shrinking the sheet of material.

### CROSS-REFERENCE TO RELATED APPLICATIONS

This application claims priority of Japanese Patent Application 2014-260641 filed on Dec. 24, 2014.

### FIELD OF THE INVENTION

The present invention relates to a wire harness and a method of manufacturing a wire harness.

### BACKGROUND OF THE INVENTION

Conventionally, a wire harness has an intermediate splice portion that electrically connects the lead wires of multiple sheathed electrical lines together, and the intermediate splice portion is covered by a water stopper so as to waterproof the wire harness (e.g., see JP 2009-136039A).

As shown in FIG. 6, a wire harness 101 disclosed in JP 2009-136039A includes an intermediate splice portion 104 in an electrical line group 103 that is made up of multiple sheathed electrical lines 102. Exposed portions of the lead wire 105 and lead wire sheathing members 106 of the sheathed electrical lines 102, which are positioned on two sides of the intermediate splice portion 104 in the lead wire axial direction, are placed on the surface of a sheet member 107 to which an adhesive has been applied. Photocurable silicone resin (not shown) is applied thereto, the sheet member 107 is wrapped around the electrical line group 103, the sheet member 107 is then rubbed by hand so that the photocurable silicone resin enters the spaces between the element wires of the exposed portions of the lead wire 105, curing the photocurable silicone resin.

JP 2009-136039A is an example of related art.

As described above, the cumbersome task of rubbing the sheet member 107 by hand is performed after wrapping the sheet member 107 around the electrical line group 103. If the photocurable silicone does not sufficiently penetrate into the spaces between the intermediate splice portion 104 and the element wires of the exposed portions of the lead wire 105, there is concern that the waterproofing of the spaces between the intermediate splice portion 104 and the element wires of the exposed portions of the lead wire 105 may be unreliable.

Accordingly, a wire harness and method of manufacturing a wire harness is desired that resolves the above-described issues, and an objective thereof is to provide a wire harness that can cause a sealing agent to sufficiently penetrate into the spaces between the element wires without requiring the task of rubbing sheet members by hand to form the water stopper, therefore making it possible to reliably waterproof the spaces between the intermediate splice and the element wires of the exposed lead wire.

### SUMMARY OF THE INVENTION

In order to achieve the above objective, a wire harness according to the present invention, is a wire harness including: an electrical line group having an intermediate splice portion that electrically connects the exposed portions of the lead wire to each other, the portions having been exposed by peeling back covering members in intermediate portions of a plurality of sheathed electrical lines; a water stopper portion formed by wrapping a sheet member one time so as to cover the exposed portion of the lead wire on one side of the intermediate splice portion to the exposed portion of the lead wire on another side, and using a heat seal or a heat-resistant adhesive to join end edges of the sheet member to each other; and a sealing agent that is applied to an inner surface of the intermediate splice portion and penetrates into and waterproofs the spaces between element wires of the exposed portion of the lead wire, wherein the sheet member forming the water stopper is made up of a heat-shrinking synthetic resin sheet that shrinks in only one axial direction when heated, and includes a plurality of raised portions that control a flow of the sealing agent, and a heat-shrinking direction of the sheet member conforms to a direction in which the sheet member is wrapped, and the intermediate splice portion water stopper shrinks in diameter to a state of close contact with the electrical line group due to being heated.

The above wire harness according to the present invention has a configuration in which a water stopper, which is formed by a heat-shrinking material that shrinks in the direction orthogonal to the axial direction of the lead wire, is formed into a tube that surrounds, in the circumferential direction of electrical line group, the intermediate splice portion of the electrical line group and the exposed portions of the lead wire and covering members of the sheathed electrical lines that are located on the two sides of the intermediate splice portion in the lead wire axial direction, and then caused to shrink by being heated. Accordingly, as the water stopper shrinks due to heat, the sealing agent is pressed toward the intermediate splice portion and the exposed portions of the lead wire.

For this reason, with the above wire harness according to the present invention, it is possible to cause the sealing agent to sufficiently penetrate into the spaces between the intermediate splice portion and the element wires of the exposed portions of the lead wire without requiring the cumbersome task of rubbing the sheets of material to form the water stopper by hand, making it possible to reliably waterproof the spaces between the intermediate splice portion and the element wires of the exposed portion of the lead wire.

The above wire harness according to the present invention is configured having the raised portions, which extend in the direction orthogonal to the lead wire axial direction and rise toward the electrical line group, on the surface of the intermediate splice water stopper that faces the electrical line group. Accordingly, when the intermediate splice water stopper is formed into a tube which shrinks in diameter, the axial direction of the flow of the sealing agent in the lead wire is controlled by the raised portions, and it is possible to cause the sealing agent to penetrate into the spaces between the element wires.

A wire harness manufacturing method according to the present invention is a wire harness manufacturing method that includes the steps of: preparing an electrical line group having an intermediate splice portion that electrically connects exposed portions of the lead wire to each other, the exposed portions being exposed by peeling back covering members in intermediate portions of a plurality of sheathed electrical lines; preparing a sheet member that is made up of a heat-shrinking synthetic resin sheet that shrinks in only one axial direction when heated, and has a size sufficient to cover a range from the exposed portion of the lead wire on one side of the intermediate splice portion to the exposed portion of the lead wire on another side, and providing a plurality of raised portions of the sheet member that correspond to two sides in a lead wire axial direction; applying a sealing agent to a surface of the sheet member on a covering inner surface side, the sealing agent penetrating into and waterproofing spaces between element wires; providing a water stopper by wrapping the sheet member one time so as to cover a range from the exposed of the lead wire on one side of the intermediate splice portion to the exposed portion of the lead wire on the other side, and using a heat seal or a heat-resistant adhesive to join the edges of the sheet member to each other; and causing the water stopper to shrink in diameter to a state of close contact with the electrical line group by heating the water stopper from the outside.

In the above wire harness manufacturing method according to the present invention, the intermediate splice water stopper, which has the sealing agent applied thereto, is formed into a tube that surrounds, in the electrical line group circumferential direction, the intermediate splice and the exposed portions of the lead wire and covering members of the sheathed electrical lines that are located on the two sides of the intermediate splice in the lead wire axial direction, and then caused to shrink by being heated. Accordingly, as the intermediate splice water stopper shrinks due to heat, the sealing agent is pressed toward the intermediate splice and the exposed portions of the lead wire.

For this reason, with the above wire harness manufacturing method described in the present invention, it is possible to cause the sealing agent to sufficiently penetrate into the spaces between the intermediate splice and the element wires of the exposed portions of the lead wire without requiring the cumbersome task of rubbing the intermediate splice water stopper by hand, and it is possible to reliably waterproof the spaces between the intermediate splice and the element wires of the exposed portions of the lead wire.

According to the present invention, it is possible to provide a wire harness that causes a sealing agent to sufficiently penetrate into the spaces between element wires without requiring the task of rubbing an intermediate splice water stopper by hand, and makes it possible to reliably waterproof the spaces between the intermediate splice portion and the element wires of the exposed portion of the lead wire, as well as a method for manufacturing this wire harness.

### BRIEF DESCRIPTION OF THE DRAWINGS

FIG. 1A is a longitudinal cross-sectional view of the completed state of a wire harness according to an embodiment of the present invention;

FIG. 1B is a transverse cross-sectional view of the completed state of FIG. 1A;

FIG. 2A is a longitudinal cross-sectional view of an electrical line group in the wire harness according to the embodiment of the present invention;

FIG. 2B is a transverse cross-sectional view of FIG. 2A;

FIG. 3 is a development view of the state before application of a sealing agent to an intermediate splice water stopper in the wire harness according to the embodiment of the present invention;

FIG. 4A is a longitudinal cross-sectional view of the harness according to the embodiment of the present invention in a state before the water stopper is formed to the intermediate splice portion;

FIG. 4B is a transverse cross-sectional view of FIG. 4A;

FIG. 5A is a longitudinal cross-sectional view of the wire harness according to the embodiment of the present invention in a state after the sealing agent is applied to the intermediate splice portion so as to form the water stopper;

FIG. 5B is a transverse cross-sectional view of FIG. 5A; and

FIG. 6 is a schematic configuration view of a conventional wire harness.

### DETAILED DESCRIPTION OF THE PREFERRED EMBODIMENT

A wire harness and a wire harness manufacturing method according to embodiments of the present invention will be described below with reference to the drawings.

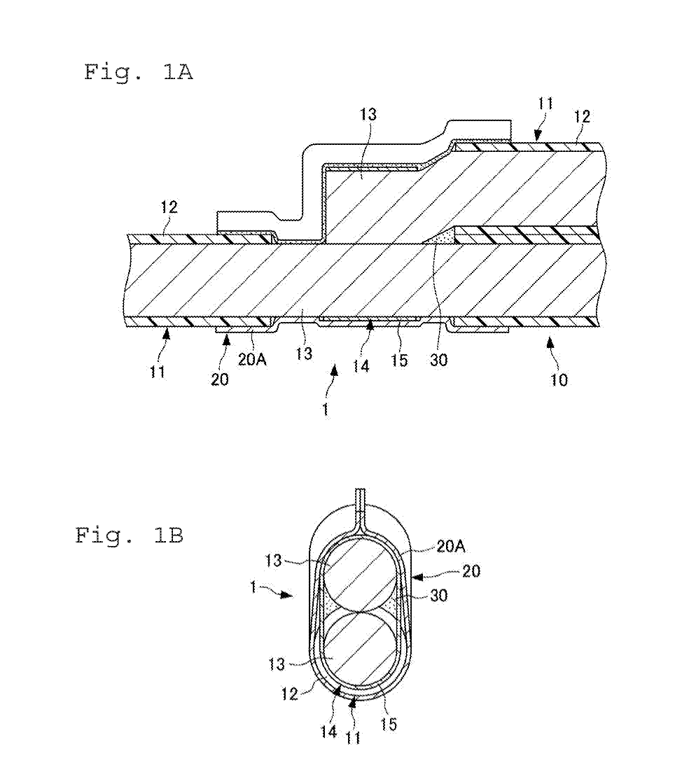

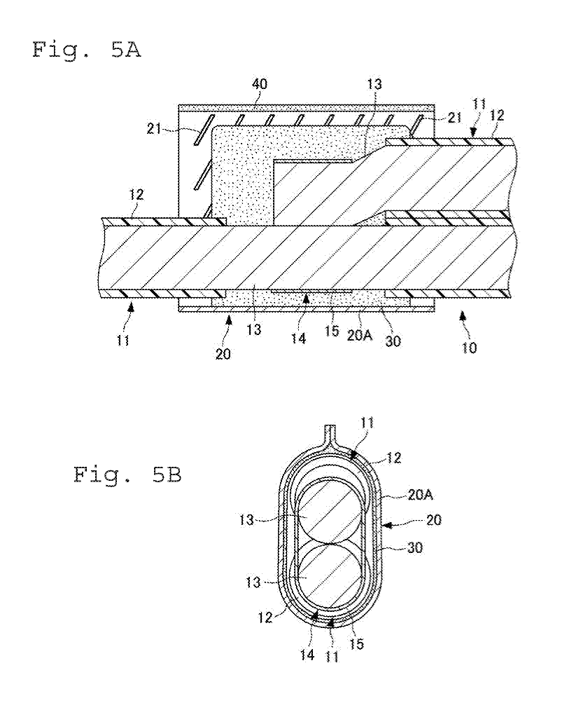

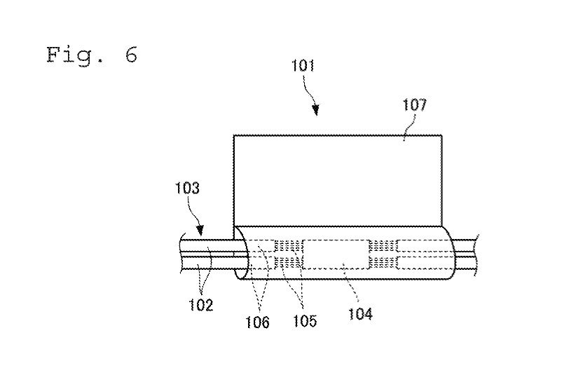

As shown in FIGS. 1A and 1B, a wire harness 1 according to the present embodiment includes an electrical line group 10, a water stopper 20, and a sealing agent 30. The electrical line group 10 has an intermediate splice portion 14 that electrically connects the exposed portions of the lead wire 13 to each other, the exposed portions of the lead wire 13 being exposed by peeling back covering members 12 in intermediate portions of sheathed electrical lines 11. The water stopper 20 is formed by a sheet member 20A that is wrapped one time so as to cover a portion from the lead wire exposed portion 13 on one side of the intermediate splice 14 to the exposed portion of the lead wire 13 on the other side, having the edges of the sheet member 20A being joined by a heat seal 40 (shown in FIG. 5A). The sealing agent 30 is applied to the inner surface of the water stopper 20 and penetrates into and waterproofs the spaces between the element wires of the exposed portions of the lead wire 13 so as to form the water stopper 20.

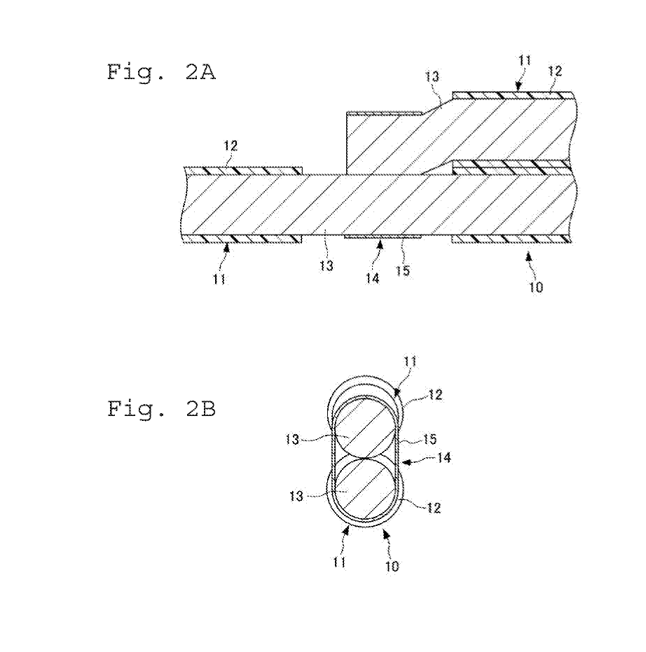

As shown in FIGS. 2A and 2B, the intermediate splice portion 14 of the electrical line group 10 has a configuration in which the exposed portions of the lead wire 13 of the sheathed electrical lines 11 are electrically connected to each other by being crimped together by an intermediate crimping terminal 15. The intermediate splice 14 may have a configuration in which the exposed portions of the lead wire 13 of the sheathed electrical lines 11 are electrically connected to each other by being welded by ultrasonic welding or resistance welding.

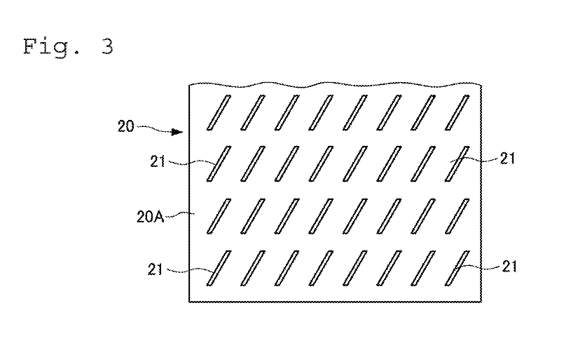

As shown in FIG. 3, the water stopper 20 includes a heat shrinking material that has waterproof properties and shrinks in the direction orthogonal to the axial direction of the lead wire when heated to a predetermined temperature. The water stopper 20 also has multiple raised portions 21 on the surface that faces the electrical line group 10, and the raised portions 21 extend in the direction orthogonal to the axial direction of the lead wire so as to rise toward the electrical line group 10. Although the raised portions 21 may have any shape and arrangement, in the simplest configuration, they are shaped as lines that are parallel to each other and inclined relative to the lead wire axis of the electrical line group 10 as shown in FIG. 3.

The sheet member 20A constituting the water stopper 20 is made up of a heat-shrinking synthetic resin sheet that shrinks in only one axial direction when heated, and the raised portions 21 that control the flow of the sealing agent 30 in the axial direction of the lead wire are provided on at least portions of the sheet member 20A that correspond to the two sides in the axial direction of the lead wire.

The heat-shrinking direction of the sheet member 20A conforms to the direction in which the sheet member 20A is wrapped, and the water stopper 20 shrinks in diameter to a state of being in close contact with the electrical line group 10 due to being heated.

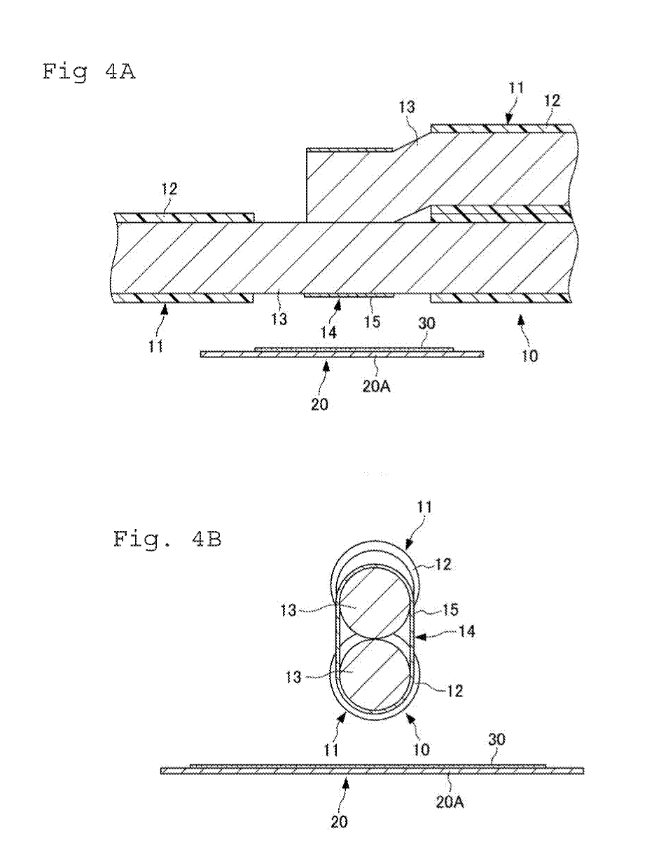

As shown in FIGS. 4A and 4B, the sealing agent 30 is applied to the surface of the water stopper 20 that faces the electrical line group 10, that is to say, the surface that has the raised portions 21. The sealing agent 30 is a publicly known type of sealing agent, such as a silicone resin sealing agent.

As shown in FIGS. 5A and 5B, the water stopper 20 with the sealing agent 30 applied thereto is formed into a tube by being arranged so as to surround, in the circumferential direction of the electrical line group, the intermediate splice portion 14 and the exposed portions of the lead wire 13 and covering members 12 of the sheathed electrical lines 11, which are located on the two sides of the intermediate splice portion 14 in the axial direction of the lead wire, and then using the heat seal 40 to join together the two end portions in the direction orthogonal to the axial direction of the lead wire. A configuration is possible in which the two end portions of the intermediate splice water stopper 20 are joined by an acrylic resin-based heat-resistant adhesive or the like instead of the heat seal 40.

After being formed into the tube as described above, the water stopper 20 is heated so as to shrink in diameter as shown in FIGS. 1A and 1B.

A method for manufacturing the wire harness 1 according to the present embodiment includes the steps of: preparing the electrical line group 10 having an intermediate splice portion 14 that electrically connects the exposed portions of the lead wire 13 to each other, the exposed portions of the lead wire 13 being exposed by peeling back covering members 12 in intermediate portions of the sheathed electrical lines 11; preparing the sheet member 20A that is made up of a heat-shrinking synthetic resin sheet that shrinks in only one axial direction when heated, and has a size sufficient to cover the portion from the exposed portion of the lead wire 13 on one side of the intermediate splice portion 14 to the exposed portion of the lead wire 13 on the other side, and providing multiple raised portions 21 on at least portions of the sheet member 20A that correspond to two sides in the lead wire axial direction; applying the sealing agent 30 to the surface of the sheet member 20A on the covering inner surface side, the sealing agent 30 penetrating into and waterproofing spaces between element wires; providing the intermediate splice water stopper 20 by wrapping the sheet member 20 one time so as to cover the portion from the exposed portion of the lead wire 13 on one side of the intermediate splice portion to the exposed portion of the lead wire 13 on the other side, and using the heat seal 40 to join end edges of the sheet member 20A to each other; and causing the water stopper 20 to shrink in diameter to a state of close contact with the electrical line group 10 by heating the intermediate splice portion water stopper 20 from the outside.

The wire harness 1 of the present embodiment has a configuration provided with the water stopper 20 that is caused to shrink in diameter by being heated from the outside. The water stopper 20 is formed from a heat-shrinking sheet member 20A that has a required size and shrinks in one axial direction when heated, and the heat-shrinking sheet member is formed into a tube by being wrapped one time so as to surround, in the electrical line group circumferential direction, the intermediate splice 14 of the electrical line group 10 and the exposed portions of the lead wire 13 and covering members 12 of the sheathed electrical lines 11 that are located on the two sides of the intermediate splice portion 14 in the lead wire axial direction, and then using the heat seal 40 to join together the end edges of the heat-shrinking sheet member. Accordingly, as the water stopper 20 shrinks due to heat, the sealing agent 30 is pressed toward the intermediate splice portion 14 and the exposed portions of the lead wire 13.

For this reason, with the wire harness 1 of the present embodiment, it is possible to cause the sealing agent 30 to sufficiently penetrate into the spaces between the intermediate splice portion 14 and the element wires of the exposed portion of the lead wire 13 without performing the task of rubbing the sheets of material by hand, and it is possible to reliably waterproof the spaces between the intermediate splice portion 14 and the element wires of the exposed portions of the lead wire 13.

The wire harness 1 of the present embodiment has a configuration in which the raised portions 21, which extend in the direction orthogonal to the lead wire axial direction and rise toward the electrical line group 10, are provided on the surface of the intermediate splice water stopper 20 that faces the electrical line group 10, and therefore the raised portions 21 control the flow direction of the sealing agent 30. In the case where the raised portions 21 are shaped as inclined lines, when the water stopper 20, which has been formed into a tube, shrinks in diameter, the angle formed by the lead wire axis of the electrical line group 10 and the raised portion 21 gradually decreases, and the raised portions 21 are pulled toward the lead wire axis of the intermediate splice portion 14, and therefore the sealing agent 30 is also pulled toward the intermediate splice portion 14, and the sealing agent 30 can be caused to sufficiently penetrate into the spaces between the intermediate splice portion 14 and the element wires of the exposed portions of the lead wire 13 in a manner similar to rubbing by hand.

As described above, a wire harness and a wire harness manufacturing method according to the present invention have an effect of being able to cause a sealing agent to sufficiently penetrate into the spaces between element wires without requiring the task of rubbing stopper sheet of material by hand, and making it possible to reliably waterproof the spaces between the intermediate splice portion and the element wires of the exposed portions of the lead wire, and are useful to general wire harnesses and wire harness manufacturing methods.

We claim:

1. A wire harness comprising:
an electrical line group having an intermediate splice portion that electrically connects exposed portions of a plurality of lead wires to each other, the exposed portions of the plurality of lead wires being exposed by peeling back covering members in intermediate portions of a plurality of sheathed electrical lines;
water stopper, the water stopper including a sheet member having opposing edges, the sheet member wrapped one time around the intermediate splice portion so as to cover a portion from an exposed portion of the lead wire on one side of the intermediate splice portion to an exposed portion of lead wire on another side of the intermediate splice portion, and the opposing edges of the sheet members joined together using a heat seal or a heat-resistant adhesive; and
a sealing agent that is applied to an inner surface of the sheet member and penetrates into and waterproofs spaces between element wires of the exposed portion of both the lead wires,
wherein the sheet member is made up of a heat-shrinking synthetic resin sheet that shrinks in only one axial direction when heated, and includes a plurality of raised portions that control a flow of the sealing agent, and
the sheet member configured to shrink in the axial direction so as to conform to a direction in which the sheet member is wrapped, and the water stopper shrinks in diameter to a state of close contact with the electrical line group in response to the application of heat.

2. A wire harness manufacturing method comprising the steps of:
preparing an electrical line group having an intermediate splice portion that electrically connects exposed portions of a plurality of lead wires to each other, the exposed portion of the plurality of lead wire being exposed by peeling back covering members in intermediate portions of a plurality of sheathed electrical lines;
preparing a sheet member that is made up of a heat-shrinking synthetic resin sheet that shrinks in only one axial direction when heated, and has a size sufficient to cover a portion from the exposed portions of the lead wire on one side of the intermediate splice portion to the exposed portions of the lead wire on another side, and providing a plurality of raised portions on at least portions of the sheet member that correspond to two sides in a lead wire axial direction;
applying a sealing agent to a surface of the sheet member on a covering inner surface side, the sealing agent penetrating into and waterproofing spaces between element wires;
forming a water stopper by wrapping the sheet member one time so as to cover a range from the exposed portion of the lead wire on one side of the intermediate splice portion to the exposed portion of the lead wire on the other side, and using a heat seal or a heat-resistant adhesive to join end edges of the sheet member to each other; and
heating the water stopper, shrinking the water stopper in diameter to a state of close contact with the electrical line group.
